(19) United States
(12) Patent Application Publication
(10) Pub. No.: US 2016/0366524 A1
(43) Pub. Date: Dec. 15, 2016

(54) Patient Communication Enhancer

(71) Applicant: Regina Holmes, Harker Heights, TX (US)

(72) Inventor: Regina Holmes, Harker Heights, TX (US)

(21) Appl. No.: 14/735,810

(22) Filed: Jun. 10, 2015

(51) Int. Cl. H04R 25/00; H04W 76/02; G06K 7/14; H04W 4/00

(52) U.S. Cl. CPC H04R 25/554; H04W 4/008; H04W 76/02; G06K 7/1417; H04W 84/18

(57) ABSTRACT

Provided is a system for communicating between a wireless microphone and a wireless speaker. A wireless microphone is wirelessly connected to a wireless hotspot. A wireless speaker is also wirelessly connected to the wireless hotspot. The wireless connections are established, e.g., by scanning respective Bluetooth barcodes. The audio input to the microphone is converted to a digital format, then transmitted to the wireless speaker via the wireless hotspot.

### TECHNICAL FIELD

This disclosure relates generally to the field of healthcare with respect to patient communication. In particular, the invention relates to systems and methods for communication between healthcare professionals and patients with hearing impairments.

### BACKGROUND

Currently, when the hearing impaired are admitted to an inpatient hospital setting or nursing home, the healthcare provider (HCP) has to rely on speaking loudly and on the patient being able to read lips when trying to effectively communicate. Speaking loudly essentially makes it easier for classified information to be inadvertently shared with people other than the patient. This is a significant HIPAA violation that cannot presently be avoided when patients have forgotten their hearing aids, misplaced them, are unable to afford them or theirs are not working properly. In addition, communication in this manner is ineffective, and can result in miscommunication of critical healthcare information. Further, even for patients that are not hearing impaired, the ability to effectively and communicate private information in a more surreptitious manner would be helpful given the sensitive information being communicated.

### SUMMARY

It is an object of the present invention to provide a means for communicating with a hearing impaired patient with the use of a microphone (for the HCP) and a speaker (for the patient), both of which are able to communicate wirelessly, preferably over a bluetooth connection. Speakers are not limited to a traditional speaker; a patient's speaker may also be a wireless headset.

Another object of the present invention is allowing an HCP to communicate with a patient that is hearing impaired, for communicating confidential patient information regarding a patient's health, or for communicating classified information when an HCP communicates with a patient. Further, even for patients that are not hearing impaired, the present invention allows for the communication of private information in a more surreptitious manner.

The present invention comprises a microphone built into the housing of a bar-code scanning device that is in communication with a handheld speaker. The speaker may include a bluetooth barcode that can be scanned to pair the speaker with the microphone. The HCP speaks into the microphone, and only the person holding the speaker to their ear will be able to hear what the HCP is saying. The microphone may communicate with the speaker via a wireless hotspot. The wireless hotspot may also include a bluetooth barcode that can be scanned, enabling the microphone to communicate with the wireless hotspot.

### BRIEF DESCRIPTION OF DRAWINGS

Embodiments are illustrated by way of example and not limitation in the figures of the accompanying drawings, in which like references indicate similar elements and in which:

FIG. 1 illustrates one embodiment of a system for communication with a patient according to one aspect of the present invention.

FIG. 2 illustrates an exemplary bluetooth barcode according to one aspect of the present invention.

FIG. 3 illustrates one embodiment of a scanner according to one aspect of the present invention.

FIG. 4 illustrates one embodiment of a method for communication with a patient according to one aspect of the present invention.

### DETAILED DESCRIPTION

The following detailed description includes references to the accompanying drawings, which form a part of the detailed description. The drawings show illustrations in accordance with example embodiments.

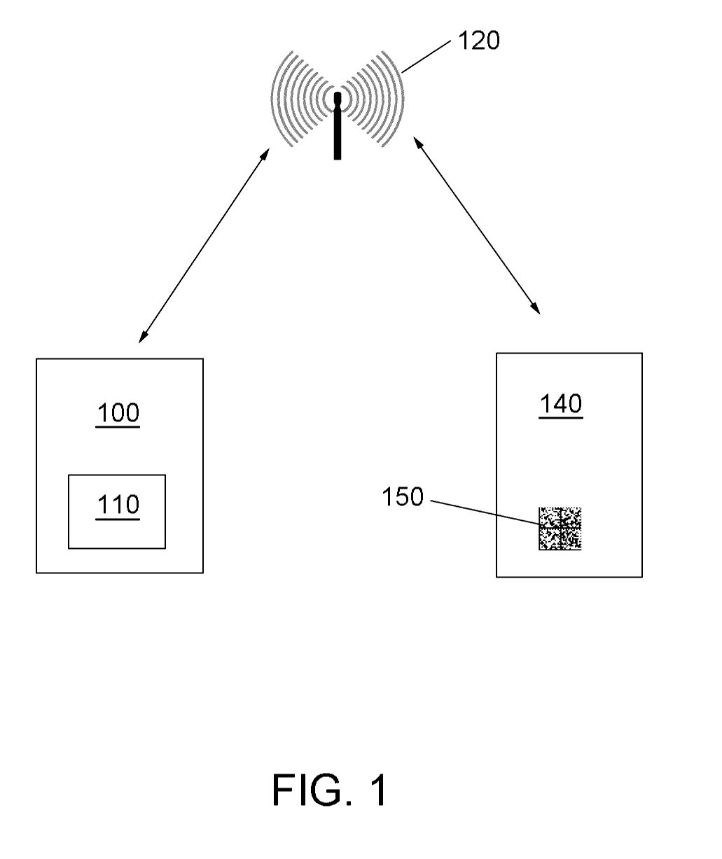

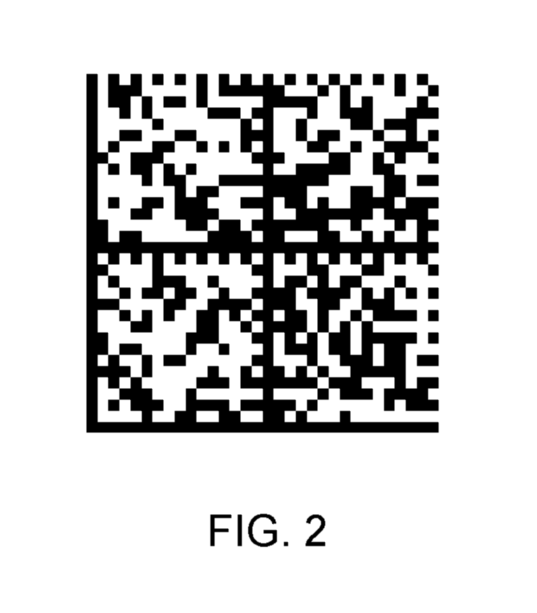

FIG. 1 illustrates one embodiment of the system of the present invention. Scanner 100 is a bar-code scanning device that can scan bluetooth codes, e.g., a Quick Connect code. An example of a Quick Connect code is illustrated in FIG. 2. Scanner 100 also includes microphone 110. Wireless hotspot 120 enables communication between scanner 100 and speaker 140, as will be understood by one of ordinary skill in the art. Wireless hotspot may have a bluetooth code that can be scanned by scanner 100. Upon scanning the bluetooth code using scanner 100, a bluetooth connection is created between scanner 100 and wireless hotspot 120, allowing communication between the two devices. Alternatively, scanner 100 may be connected to wireless hotspot 120 via other means, such as a bluetooth device scan. One of ordinary skill in the art will recognize other ways for scanner 100 and hotspot 120 to be connected, and these other connection methods are also considered to be within the scope of the invention.

FIG. 1 also includes speaker 140, which may have a bluetooth code, e.g., bluetooth code 150 that can be scanned by scanner 100. Upon scanning bluetooth code 150 using scanner 100, a bluetooth connection is created between scanner 100 and speaker 140, via hotspot 120, allowing communication between scanner 100 and speaker 140. Alternatively, scanner 100 may be connected to speaker 140 via other means, such as a bluetooth device scan. One of ordinary skill in the art will recognize other ways for scanner 100 and speaker 140 to be connected, and these other connection methods are also considered to be within the scope of the invention.

After the respective bluetooth codes have been scanned by scanner 100, or an alternative means of connecting scanner 100 with speaker 140 have been performed, the HCP can speak into microphone 110, and the audio input to microphone 110 will be output only to speaker 140, so only the intended recipient will hear what the HCP is saying.

FIG. 2. illustrates an example bluetooth code, in this case, a Quick Connect code. The code can be scanned in by a scanner and converted into a bluetooth identifier by techniques known to one of ordinary skill in the art.

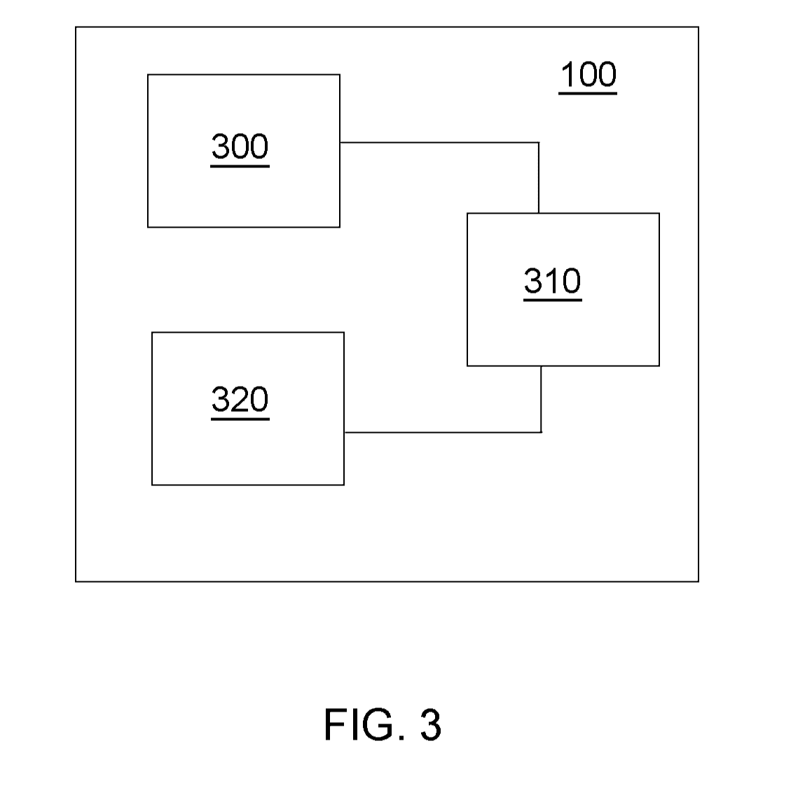

In FIG. 3 is depicted an example embodiment of scanner 100. Scanner 100 may include scanner module 300, communication module 310, and microphone 320. Scanner module 300 is configured to be able to scan a barcode, e.g. a bluetooth barcode as illustrated in FIG. 2. Scanner module 300 then converts the scanned barcode into a number or other identifier of a bluetooth device. This identifier is then passed to communication module 310, which initiates a communication path to the identified bluetooth device. If a second bluetooth barcode is scanned, the communication path will also include the bluetooth device identified by the second barcode, e.g., a speaker. After the communication path has been established, audio picked up by microphone 320 is converted into a digital format, then passed to communication module 310, which in turn wirelessly sends the converted audio to the recipient bluetooth device. The conversion of the audio and the wireless communication of the converted audio data are done by techniques well known in the art.

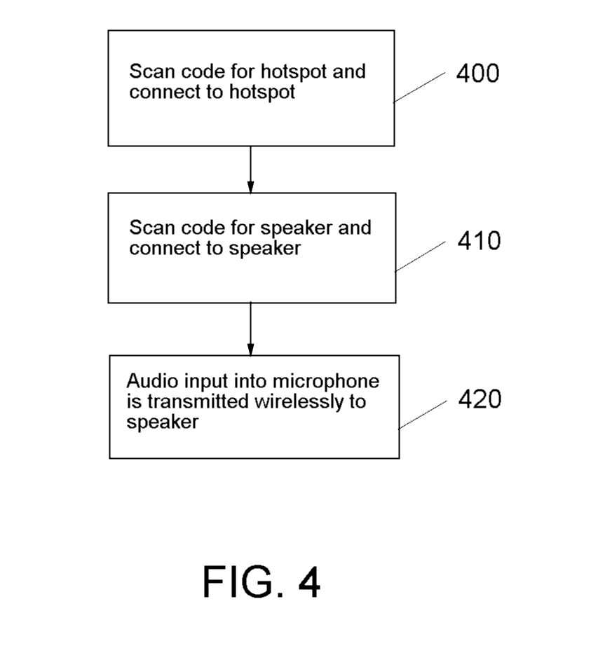

A method according to the principles of the present invention is illustrated in FIG. 4. In step 400, bluetooth code 130 is scanned by scanner 100, connecting the scanner to the wireless hotspot. Then, in step 410, bluetooth code 150 is scanned, thus pairing speaker 140 to microphone 110 by way of hotspot 120, that was activated in step 400 by scanning the first barcode. In step 420, the HCP speaks into microphone 110, and the audio input to microphone 110 is wirelessly transmitted to speaker 140 and is output by speaker 140.

Although the invention has been described in terms of particular embodiments, one of ordinary skill in the art, in light of the teachings herein, will be able to generate additional embodiments and modifications without departing from from the spirit of, or exceeding the scope of, the claimed invention. This invention is not limited to using the particular elements, materials, or components described herein, and other elements, materials, or components will be equivalent for the purposes of this invention. Accordingly, it is understood that the drawings and the descriptions herein are proffered only to facilitate comprehension of the invention and should not be construed to limit the scope thereof

What is claimed is:

1. A system for communicating, comprising:
a. a wireless microphone that is wirelessly connected via a first wireless connection to a wireless hotspot; and
b. a wireless speaker that is wirelessly connected via a second wireless connection to the wireless hotspot;
c. whereby the audio input detected by the microphone is converted to a digital format and transmitted to the speaker via the wireless hotspot.

2. The system of claim 1, wherein the first and second wireless connections are Bluetooth connections.

3. The system of claim 2, wherein the Bluetooth connections are established by scanning respective Bluetooth barcodes.

4. The system of claim 1, wherein the wireless microphone comprises a scanner for scanning a Bluetooth barcode.

5. The system of claim 4, wherein the first wireless connection is established by scanning a Bluetooth barcode associated with the wireless hotspot.

6. The system of claim 4, wherein the second wireless connection is established by scanning a Bluetooth barcode associated with the speaker.

7. A wireless microphone for communicating, comprising:
a. a scanner for scanning a Bluetooth barcode; and
b. a microphone;
c. wherein the microphone converts audio input to a digital format and transmits the converted audio input via a Bluetooth wireless connection

8. The wireless microphone of claim 7, wherein the wireless microphone is paired with a wireless speaker upon scanning a Bluetooth barcode associated with the wireless speaker.

9. The wireless microphone of claim 7, wherein the Bluetooth wireless connection is established by scanning a Bluetooth barcode associated with the wireless connection.

10. A method for communicating, comprising:
a. scanning a Bluetooth barcode associated with a wireless hotspot;
b. establishing a first wireless connection between a microphone and the wireless hotspot;
c. scanning a Bluetooth barcode associated with a wireless speaker; and
d. establishing a second wireless connection between the wireless hotspot and the speaker;
e. wherein the audio input detected by the microphone is converted to a digital format and transmitted to the speaker via the wireless hotspot.

11. The method of claim 10 wherein the first wireless connection is a Bluetooth connection.

12. The method of claim 10 wherein the second wireless connection is a Bluetooth connection.

13. The method of claim 10 wherein the first and second wireless connections are Bluetooth connections.
